(19) United States
(12) Patent Application Publication
(10) Pub. No.: US 2009/0273481 A1
(43) Pub. Date: Nov. 5, 2009

(54) Solar-Charged Power Source

(76) Inventors: John Traywick, Hoover, AL (US); Daniel Ulrich, Hamilton, OH (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/261,685

(22) Filed: Oct. 30, 2008

Related U.S. Application Data
(60) Provisional application No. 61/021,184, filed on Jan. 15, 2008.

(51) Int. Cl. H01M 10/46; G08B 21/00

(52) U.S. Cl. 340/636.1; 320/101

(57) ABSTRACT

A solar-charged power source for use in powering an electronic device, such as a game camera, comprises a housing, a photovoltaic cell provided on an upper surface of the housing, a battery and electronic circuitry, including a microcontroller, contained within the housing. A display is mounted on an outer surface of the housing and provides a user selectable indication of a microcontroller determined condition of the power source including the current charge state of the battery, a real time solar value indicating the electrical current production of the photovoltaic cell, a computed daily solar average and a weekly solar average of the current produced by the photovoltaic cell, based on the energy consumption requirements of the powered device.

### CROSS-REFERENCE TO RELATED APPLICATIONS

This application claims the benefit of prior U.S. Provisional application Ser. No. 61/021,184, filed Jan. 15, 2008, the disclosure of which is incorporated herein by reference.

### FIELD OF THE INVENTION

The invention relates to photovoltaic power cells. More particularly, the invention relates to a solar charged battery source for use in powering an electronic product, such as a game camera. More specifically, the battery source enables a user to select a location for optimal use of the solar panel based on real time and historical performance information.

### SUMMARY OF THE INVENTION

Briefly described, the present invention is a solar-charged power source for supplying electrical energy to an electronic device, such as a game camera. The invention comprises a photovoltaic cell for converting a light from a source, namely the sun, into electricity; a battery for storing at least a portion of the electricity converted by the photovoltaic cell; and an electrical circuit in communication with the battery, photovoltaic cell, and the electronic device; the electrical circuit comprising a microcontroller for managing electricity generated by the photovoltaic cell between the power source, battery and electronic device. The photovoltaic cell, the battery, and the electrical circuit are mounted in a housing having a bracket pivotally attached thereto for mounting the power source to a supporting structure. The pivotal attachment of the housing to the bracket permits adjustment of the housing so that the photovoltaic cell may be positioned to optimally receive light thereon.

The microcontroller of the solar-charged power source is in electrical communication with an electronic display panel, such as an LCD, providing a user with an indication of a plurality of conditions to determine the operational status of the device. A first of the conditions is an indication of the intensity of the light received from the source by the photovoltaic cell, so that the photovoltaic cell may be positioned for optimum light reception and performance. A second of the plurality of conditions provides the user an indication of the charge condition of the battery associated with the device. A third of the plurality of conditions is an indication of the electricity converted by the photovoltaic cell during a predetermined period, typically the predetermined period is approximately twenty four hours. A fourth condition is an indication of the electricity converted by the photovoltaic cell during a plurality of predetermined periods, such as a seven day period, for a weekly average value. The displayed condition may be based on a user selection, or alternatively may it be automatically displayed based on instructions in the microprocessor.

### BRIEF DESCRIPTION OF THE DRAWINGS

FIG. 1 is a top perspective view of the solar charged power source.

FIG. 2 is a bottom perspective view of the solar-charged power source.

FIG. 3 is a schematic view of the internal circuitry of the solar-charged power source.

FIG. 4 is a flowchart illustrating process implemented by the microcontroller of the solar-charged power source.

FIG. 5 is a side perspective view illustrating the display for the solar-charged power source.

FIG. 6 is a side perspective view of the solar-charged power source.

FIG. 7 is a back plan view of the solar-charged power source.

FIG. 8 is a top end view of the solar-charged power source.

FIG. 9 is a right side view of the solar-charged power source.

FIG. 10 is a left side view of the solar-charged power source.

FIG. 11 is a frontal view of the solar-charged power source.

FIG. 12 is a bottom end view of the solar-charged power source.

### DETAILED DESCRIPTION OF THE INVENTION

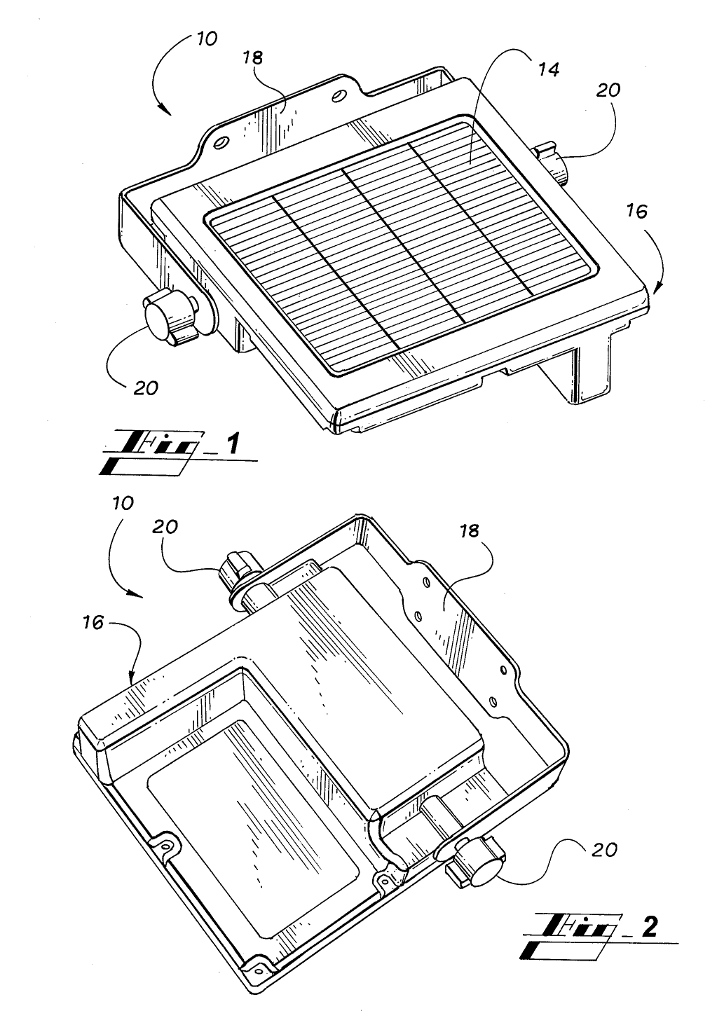

Looking to FIGS. 1 and 2, a solar charged battery device 10 to provide electrical current for the operation of electronic equipment 12 is illustrated. In particular, the device 10 serves as an external power source providing electric current to various electronic products 12, such as digital game cameras used in the field. The device 10 includes a solar panel 14 or cell that is mounted to a housing 16. The housing 16 is pivotally connected to a base bracket 18. Base bracket 18 may be attached in a variety of ways such as through the use of conventional connectors similar to U-bolts or bungee straps to a variety of secure bases such as a tree, limb, stump, pole, or similar solid member. In particular, the housing 16 may be pivotally connected to the bracket 18 using wing-nuts 20, such that the relative position between the housing 16 and the bracket 18 may be adjusted and locked to achieve an optimal angle at the specific location where the device is mounted for the purposes described herein.

The housing 16 contains an electrical circuit 22 that includes the solar panel 14, an output junction 25, and a battery 24, such as a rechargeable 12-volt battery. The solar panel 14, which may be any photovoltaic cell known in the art, is designed to convert light into electricity that is to be supplied to both the rechargeable battery 24 and an electronic product. Thus in this particular application, while the solar panel 14 is exposed to light during the day, it will provide electricity for operation of a game camera as well as recharging the battery 24.

The electric circuit 22 includes a microcontroller 26 or integrated circuit that is in electrical communication with both the solar panel 14 and the battery 24. The microcontroller 26 is used to for various functions, with one function being to monitor the amount of current generated by the solar panel 14, and provide corresponding information to the user via a display 28, such as a liquid crystal display (LCD), so that the device 10 may be positioned in the most desirable location possible for receiving the required light. In particular, the solar cell 14 is connected to the microcontroller 26 across a resistive load R5, which provides values of the current to be interpolated by the microcontroller 26 as described herein. Further, the microcontroller 26 includes an integrated LCD driver to transmit the monitored information to the display 28. Although a variety of microcontrollers 26 may be used as described herein, the model known to operate suitably is a Microchip PIC16F91X.

The microcontroller 26 manages the solar energy effectively to power the camera, keep an internal battery 24 charged, and maintain a correct charge on an internal battery 24 so as not to overcharge it. That is, the microcontroller 26 will measure the charge on the battery 24 over a period of time to determine whether current generated by the solar cell 14 is to be directed to the power source 24 or to the product 12. The microcontroller 26 has four functions to assist the user, including:

1) The microcontroller 26 is connected to an electronic display 28 on the device 10 acting as a solar meter that measures the intensity of the solar energy being received, so the user can place the unit in the most effective place.

2) The microcontroller 26 keeps up with the charge on the internal battery 24. It will let the user know what the current state of charge is in the battery 24.

3) The microcontroller 26 tracks the daily amount (over a predetermined period, such as a 24 hour period) of power that the solar panel 14s of the device 10 produce, and it displays this information to the user.

4) The microcontroller 26 tracks the weekly average of power that the device 10 has produced over the last week per day.

Thus, the microcontroller 26 provides four readouts to the user, namely, (1) real-time solar charge, (2) internal charge, (3) daily solar charge, and (4) weekly solar charge. These readouts are displayed to the user to assist the user in tracking the actual performance of the device 10 in the field based on the position of the device 10. The first three readouts analyze the amount of current produced by the solar panel 14, while the internal charge readout determines the energy stored via the battery 24 connected to the solar panel 14.

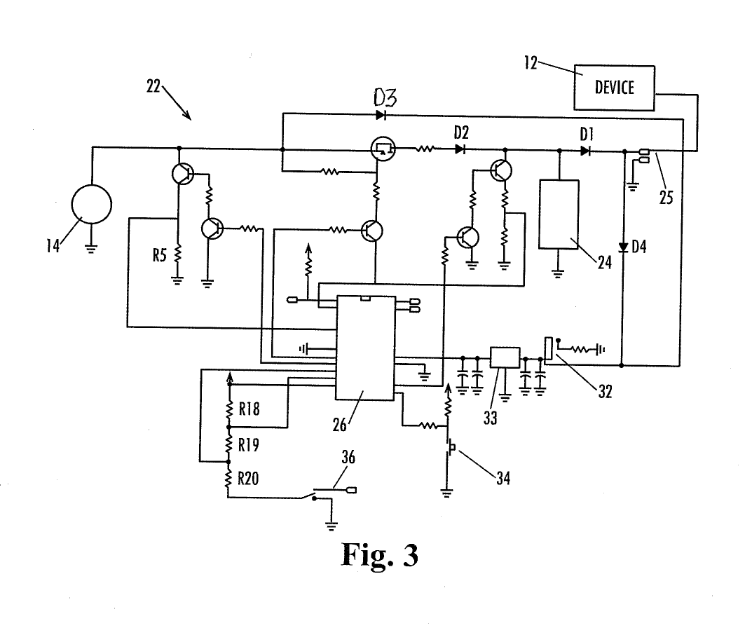

Looking at the circuit diagram of FIG. 3, the solar cell 14 is connected to the battery 24 and output port 25 used to provide electricity to the game camera 12. Battery 24 is also connected being connected to output port 25 to provide electricity to the game camera 12 or other electronic product. A rubber plug strip covers the external power port 25, which is easily detached to allow the user to plug in a cable 27 connecting the device 10 with the product 12. The solar cell 14, via D3, and battery 24, via D4, are additionally connected to the On/Off switch 32. Voltage regulator 33 is positioned between the microcontroller 26 and on off switch 32. Voltage regulator 33 is preferably comparable to one of the XC6202 series, a highly precise, low power consumption, high voltage, positive voltage regulator consisting of a current limiter circuit, a driver transistor, a precision reference voltage and an error correction circuit. Output voltage supplied to the circuit by Voltage regulator 33 is +5 volts.

The solar panel 14 is connected to the microcontroller/integrated circuit 26 via transistor Q9 at pin RA3, with a load resistor R5 of 49.9 ohms shunted between Q9 and the microcontroller 26. The microcontroller 26 therefore monitors the voltage drop over this resistor when Q9 is conducting thereby indicating the current generated by solar cell 14. RA3 is the input to an analog to digital converter in microcontroller 26. Using this information, the microcontroller 26 is programmed to calculate a Real-Time Solar (RTS) value, a Daily Solar Average (DSA) value, and a Weekly Solar Average (WSA) value of current produced by the solar cell 14. The RTS value indicates the dynamic level of current produced when the solar panel 14 is connected across load R5. Using a 70 mA solar panel 14, the minimum acceptable solar output current indication is 82 counts on the 10-bit analog/digital converter of the microcontroller 26 (which is 0.4V across a 49.9 ohm resistor or about 8+/−4 mA). During testing, it was found that a good high current (not the maximum) could be 614 counts on the 10-bit A/D converter of the microcontroller 26 (which is 3.0V across 49.9 ohms or about 60 mA+/−4 mA). While the actual solar-generated charge retained in the battery 24 is somewhat dependant on the type of battery 24 used in the design (e.g., internal resistance, current charge level) and typically a sealed lead acid (“SLA”) battery only retains about 70% of the energy delivered), this RTS value is a true representation of the current generation capabilities of the solar panel 14 in real-time to assist the user in selecting the optimal location for generating current.

The calculation for the RTS value, scaled from 0 to 100, with 100 corresponding to a desired current production of 60 mA, is performed by the microcontroller 26 using the following formula:

(A/D_Count−82)*100)/532.

Based on the electronic equipment expected to be used with the present device 10, solar currents that are 60 mA or over are indicated as an interpolated value of “100” (or an ideal spot to position the solar panel 14). Of course, the use of other equipment with this device 10 that requires more current for operation will adjust the RTS value. That is, if the equipment requires 350 mA, then the RTS value corresponding to 100 would be equivalent to 350 mA rather than 60 mA.

The microcontroller 26 will also calculate the DSA value. Specifically, the value of A/D counts across the 49.9 ohm resistor R5 are read every minute by the microcontroller 26 via the connection at pin RA3. This A/D value is converted to a milliamps value accurate to one decimal place and then added to a DSA accumulator also maintained in the microcontroller 26. The conversion is based on empirical data collected from several solar panels 14. As a side note, since this conversion is based on data collected from the solar panels 14, the solar panels 14 must be in tolerance in order for the display to be accurate. After 1440 minutes (one 24-hour day), the Daily Solar Sum accumulator is divided by a value such as 1440 (corresponding to the number of minutes in the day), to determine the Daily Solar Average value available from the solar cell. Recall that some of this energy goes to the battery 24 and some of the energy goes to the product (e.g., the camera).

To get the power savings needed on the device 10, the microcontroller 26 selected for the device 10 has a low frequency, un-calibrated oscillator. This oscillator has a nominal frequency of 31 Khz; however, it can drift based on temperature and other factors. This means that timers based on the oscillator can vary based on temperature as well as from microcontroller 26 to microcontroller 26. The DSA value is designed to be the average for the previous 24 hours. However, in worse case extremes, the average can drift without the use of additional components. In such cases, the timing can drift based on temperatures and other extraneous factors, and the “Day” could be the average from the previous 15-30 hours depending on drift of the oscillator. Since the length of the monitored “Day” can vary, the Daily Average is described as the running average for the predetermined “Day” and not necessarily defined as a standard 24-hour day.

Finally, the microcontroller 26 also calculates the WSA value using a WSA accumulator, which is the average of seven daily averages. That is, the microcontroller 26 will add the DSA value for a predetermined number of days and divide the total by the number of days. The WSA value is dependant on the calculations of the Daily Solar Average, and will thus be adjusted as the DSA value is adjusted. Microcontroller 26 outputs the selected data to LCD 28 via jumper X.

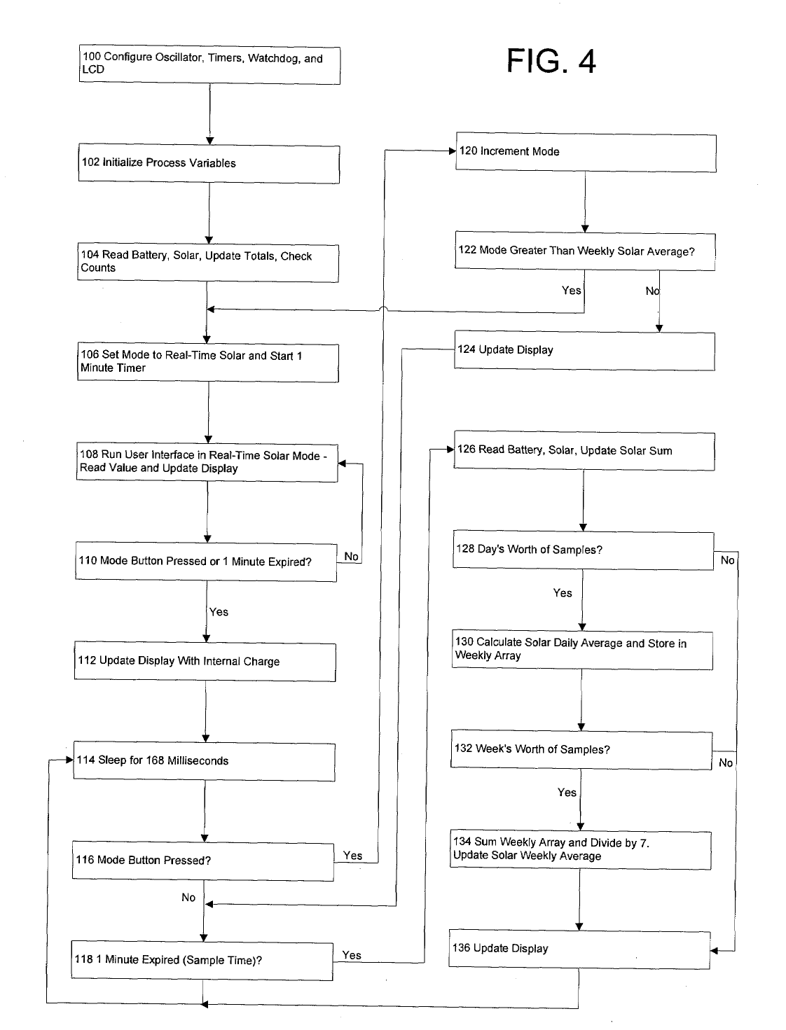

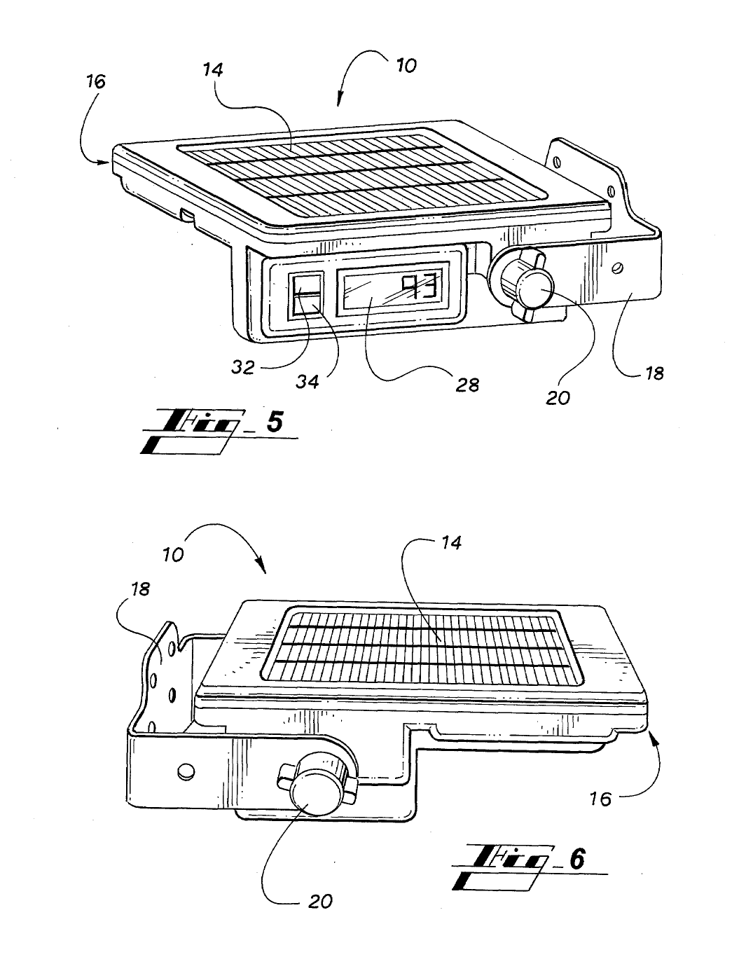

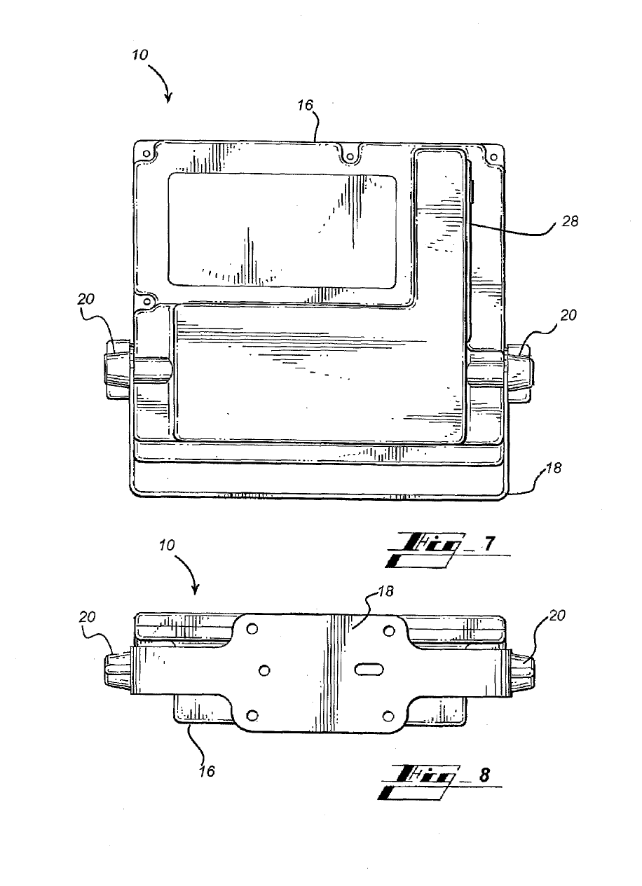

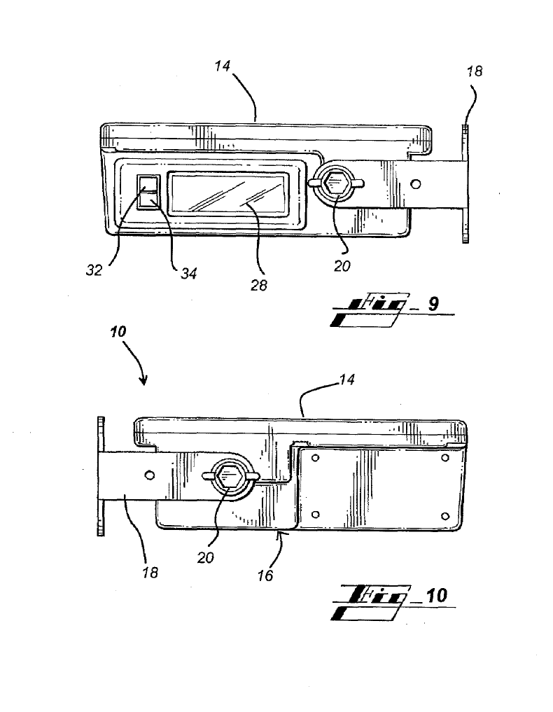

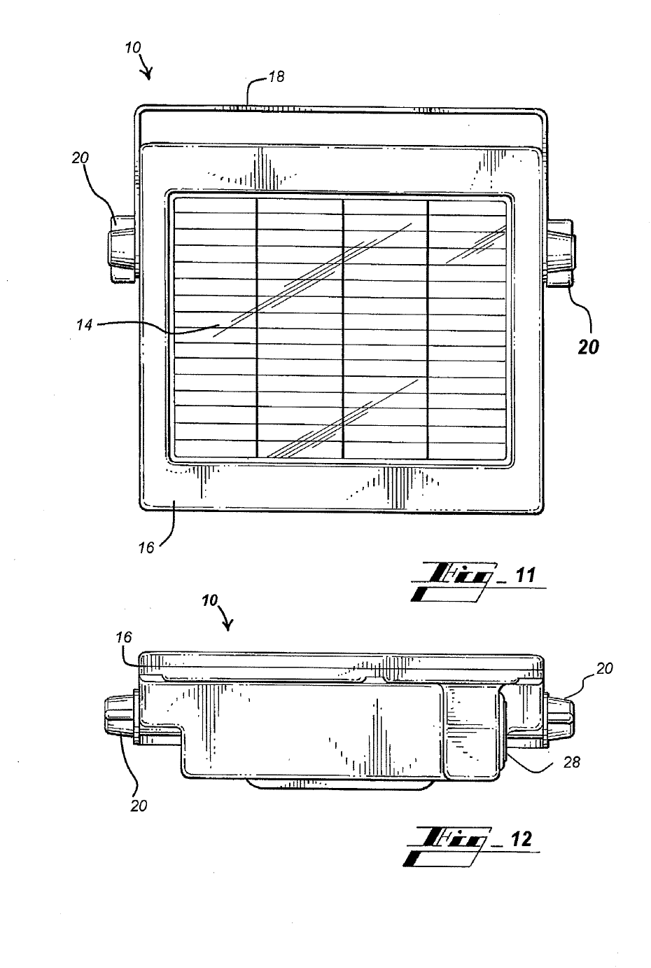

The process implemented by the microcontroller 26 of the device 10 is illustrated in the flow chart shown in FIG. 4. Initially, the device 10 is turned on by the user via the external On/Off button 32, shown in FIGS. 3 and 5. The microcontroller 26 will configure the oscillator, timers, watchdog timer (used to wake-up the circuit 22 when in sleep mode), and LCD (step 100), and further initialize the process variables (step 102), such as clearing out all accumulator variables maintained by the microcontroller 26, including the Daily Solar Average and Weekly Solar Average. The microcontroller 26 will then check the battery 24 and solar cell 14 operating information and update the totals (step 104). Initially, the device 10 will operate in Real-Time Solar Mode, and a one-minute timer maintained by the microcontroller 26 is initiated (step 106). The microcontroller 26 will read the Real Time Solar value and show the value on the display 28 for the user to read (step 108). If the mode button 34 is pressed or if the one-minute period has expired as checked by the microcontroller 26 (step 110), the microcontroller 26 will transition to the Internal Charge mode and update the display 28 with the Internal Charge of the battery 24 (step 112). If the mode button 34 is not pressed in step 110, then step 108 is repeated. The microcontroller 26 will then go into sleep mode for a predetermined period, which in the embodiment described herein, is 168 milliseconds (step 114).

At the end of the predetermined period, the microcontroller 26 will check to see if the mode button 34 is pressed (step 116). If so, then the mode will be incremented to Daily Solar Average mode (step 120). The microcontroller 26 will then check whether the mode is greater than the Weekly Solar average (step 122), and if not, the Daily Solar Average will be shown on the display 28 (step 124), and the process with then return to step 118. If the mode is greater than the Weekly Solar Average at step 120, then the process will return to step 106. If the mode button 34 is not pressed by the user, the microcontroller 26 will check the one-minute timer to determine whether one-minute (or some other preset time limit) has expired.

If the mode button 34 is not pressed at step 116, then the microcontroller 26 will check the one-minute timer to see if one minute has expired (step 118). If so, the microcontroller 26 transitions to step 126 to read the battery 24 and solar values and update the Daily Solar Average. At step 128, the microcontroller 26 checks to see if it has received one days worth of samples (i.e., 1,440 samples). If no, then the display 28 is updated (step 136) and the microcontroller 26 returns to step 114. If the microcontroller 26 has collected one days worth of samples at step 128, the microcontroller 26 will calculate the Solar Daily Average to be stored in a weekly array (step 130). The microcontroller 26 will then check to see if it has one week's samples (i.e., 10,080 samples) for the preceding week (step 132). If so, at step 134, the weekly data is added together and divided by the predetermined period set for the week (conventionally seven days), and the display 28 is updated with the Weekly Solar Average (step 136). This process will continue until the user once again selects the On/Off button 32, turning the device 10 off and further clearing and resetting the various variables maintained by the microcontroller 26 monitoring the real-time, daily and weekly charges of the device 10.

To recap, as the microcontroller 26 proceeds through each mode, the LCD will display the correct mode for the user as well as the value corresponding to the mode. The Real-Time Solar Mode variable indicates the amount of real-time solar energy that is being received by the device 10. During setup, this screen can be used to position the solar panel 14 in the optimal position. Anywhere from 4 to 8+ hours of direct sun is required for optimal performance depending on camera model. Direct Sun is a Real Time Solar value of 50 or greater. The Real Time Solar screen will remain active for one minute before changing to the Internal Charge screen. To make active again after one minute, press the Mode button 34 until the Real Time Solar screen is displayed.

In the Internal Charge Mode, the device 10 internally retains a solar charge so that it can continue to deliver energy to the camera through the night or on cloudy days. If this value drops below 50 on the display 28, the device 10 may not be receiving enough solar energy and the user should consider selecting a sunnier location. Also, if the Internal Charge drops below 50 on the display 28, it may be advantageous to do a complete re-charge on the unit. In this case, with power ON and the camera disconnected, set the device 10 in the direct sunlight for up to 8 hours or until the internal charge value is greater than 90.

In the Daily Solar Average Mode, the device 10 tracks the amount of solar energy it receives each day. In the Weekly Solar Average Mode, the Weekly Solar Average is the average Solar Energy Level over the past week. In both the Daily and Weekly Solar Average modes, the variables are cleared and reset when the device 10 is turned off.

Thus, this device 10 provides: the combination of a solar panel 14, a rechargeable battery 24 and management microcontroller 26 and software; the “real-time solar” meter to aid the user in setting up the device 10 in the best location; the ability to show the internal battery 24 charge; the ability to track weekly and daily averages of electrical current produced by the device 10 to also aid the user in the optimal placement of the product; and the ability to correctly maintain a battery 24 charge in the device 10 and not overcharge the battery 24.

The device 10 manages the power produced by the solar panel 14 to directly power the camera or other product as well as charge the internal battery 24 of the device 10 to run the camera through the night or for a period of days of rain or bad weather when a solar panel 14 alone could not supply power to run the game camera. It provides the user with a readout for optimal solar panel 14 placement. It further provides the user the ability to see the state of charge of the battery 24 state of charge, and displays the actual electrical current produced by the panel 14 on a daily and weekly average.

Referring again to FIG. 4, a jumper switch 36 may additionally be connected to the microcontroller 26 to conserve power used by the microcontroller 26 in biasing the LCD 28. That is, the jumper switch 36 is typically connected to ground, and the resistors R18, R19, and R20 are used to control the bias of the LCD 28. When the switch 36 is turned to the on-position, power is taken off of these resistors R18, R19, and R20. While this is not necessary for proper operation of the device 10, it may nonetheless assist the user in conserving the power generated by the solar cell 14.

Additional features may be incorporated into the device 10 to monitor the current production and use. For example, the microcontroller 26 may additionally calculate how much solar power is needed for the electronic product 12 based on the power being consumed daily on average. That is, the microcontroller 26 will monitor the outgoing current drawn by the electronic product 12 during a predetermined period (such as one day) and save that value as a reference value. This reference value is then compared with the Daily Solar Average (or comparable value) to determine if the solar cell 14 is producing the required current at its location. If so, the microcontroller 26 will transmit a message on the display 28 that the location is acceptable for proper use. If not, the microcontroller 26 will transmit a message on the display 28 that the device 10 needs to be moved to a new location.

It should be understood that the portion of the circuit actually involved in charging battery 24 and powering device 12 has been illustrated in FIG. 4, but has not been verbally described in as much as the features claimed herein are not dependant upon those particulars. While a single embodiment of the present invention is shown in the drawings, it is not intended that the invention be so limited but rather that the invention be defined by the appended claims when given their full and broadest scope.

I claim:

1. A solar-charged power source for supplying electrical energy to an electronic device comprising: a photovoltaic cell for converting light into electricity; a battery for storing at least a portion of said electricity converted by said photovoltaic cell; an electrical circuit in communication with said battery, said photovoltaic cell, and providing a connection to said electronic device; said electrical circuit comprising a microcontroller for monitoring and distributing the output generated by said photovoltaic cell between said power source, said battery and said electronic device wherein said microcontroller is in electrical communication with an electronic display panel to selectively provide an indication of a plurality of conditions.

2. The solar-charged power source of claim 1, wherein a first of said plurality of conditions an indication of the level of intensity of light received by said photovoltaic cell.

3. The solar-charged power source of claim 1, wherein a second of said plurality of conditions is a charge condition of said battery.

4. The solar-charged power source of claim 1, wherein a third of said plurality of conditions is value of said electricity converted by said photovoltaic cell during a predetermined period.

5. The solar-charged power source of claim 4, wherein said predetermined period is approximately twenty four hours.

6. The solar-charged power source of claim 1, wherein a fourth of said plurality of conditions is a value of said electricity converted by said photovoltaic cell during a plurality of said predetermined periods.

7. The solar-charged power source of claim 6, wherein said plurality of said predetermined periods is approximately seven days.

8. The solar-charged power source of claim 1, wherein said indication is automatically updated based on the condition of said power source.

9. The solar-charged power source of claim 1, further comprising a housing for said battery, said electrical circuit and said photovoltaic cell, wherein said photovoltaic cell is mounted in an upper surface of said housing.

10. The solar-charged power source of claim 9 further comprising a mounting bracket pivotally attached to said housing.

11. A solar-charged power source for supplying electrical energy to an electronic device comprising:
a photovoltaic cell for converting light into electrical energy; a battery for storing at least a portion of said electrical energy converted by said photovoltaic cell; a microcontroller for managing an electrical current generated by said photovoltaic cell between said power source, said battery and said electronic device; and a panel displaying an indication of a plurality of conditions of said power source.

12. The solar-charged power source of claim 11, wherein one of said conditions of said power source comprises a current state of charge of said battery.

13. The solar-charged power source of claim 11, wherein one of said conditions of said power source comprises a real time solar value.

14. The solar-charged power source of claim 11, wherein one of said conditions of said power source is a daily solar average value.

15. The solar-charged power source of claim 11, wherein one of said conditions of said power source is a weekly solar average value.

16. A solar-charged power source for supplying electrical energy to an electronic device comprising:
a housing; a photovoltaic cell for converting a light source into an electricity mounted on an upper surface of said housing; a battery for storing at least a portion of said electricity converted by said photovoltaic cell;
a microcontroller for managing an electrical current generated by said photovoltaic cell between said power source, said battery and said electronic device; and a panel displaying a user selectable indications of one of a plurality of operational conditions of said power source computed by said microcontroller.

17. The solar-charged power source of claim 19, wherein said plurality of conditions comprise a real time solar value, a battery charge value, a daily solar average value, and a weekly solar average value.

18. A process of for indicating to a user an operational performance characteristic of a solar-charged power source for powering an electronic device, the power source comprising: a photovoltaic cell for converting a light source into electricity; an internal battery for storing said electricity; an output for providing electrical communication between said power source and said electronic device; a electronic circuit comprising a microcontroller in electrical communication with said photovoltaic cell, said internal battery, and said output; and a display for providing indicia of said operational performance characteristic, the process comprising the steps of:
a. sampling the electrical energy converted by said photovoltaic cell at a first predetermined interval;
b. calculating in said microcontroller a real time solar value relative to a power requirement for said electronic device; and
c. displaying indicia of said real time solar value on said display.

19. The process of claim 18, further comprising the steps of adding said real time solar value to an accumulator at the end of said first predetermined interval, iteratively calculating a real time solar value for subsequent equal intervals with each real time solar value being added to said accumulator at the end of a corresponding interval, calculating a first average solar value when sufficient real time solar values have been accumulated and displaying indicia of said first solar average.

20. The process of claim 19 further comprising the step of calculating a second average solar value when sufficient first average solar values have been accumulated and displaying indicia of said second solar average value.

21. The process of claim 20, wherein said first predetermined interval is approximately one minute.

22. The process of claim 20, wherein said first average solar value is a daily solar average.

23. The process of claim 20, wherein said second average solar value is a weekly solar average.

24. The process of claim 20, wherein display of said real time solar value, said first average solar value, and said second average solar value are selectable by a user.

25. The process of claim 18, further comprising the step of determining a charge state of said battery.

26. The process of claim 25, further comprising the step of displaying indicia of said charge state after the expiration of said first predetermined interval.
